(19) United States
(12) Patent Application Publication
(10) Pub. No.: US 2008/0085703 A1
(43) Pub. Date: Apr. 10, 2008

(54) Apparatus, method and computer program product providing user equipment self-terminating reporting technique

(75) Inventors: Per Michaelsen, Aalborg (DK); Troels E. Kolding, Klarup (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/973,030

(22) Filed: Oct. 4, 2007

Related U.S. Application Data
(60) Provisional application No. 60/850,108, filed on Oct. 6, 2006.

(51) Int. Cl. H04Q 7/20

(52) U.S. Cl. 455/422.1

(57) ABSTRACT

An apparatus includes a radio frequency transceiver and a channel quality indicator module connected with the transceiver. The channel quality indicator module is configurable to determine at least one characteristic of a channel received through the transceiver and to prepare a channel quality indicator report comprised of a plurality of channel quality indicator fragments. The channel quality indicator module is further configurable to transmit a first channel quality indicator fragment to a wireless network through the transceiver, where the first channel quality indicator fragment comprises information sufficient for use by a network node to make a resource scheduling decision, and to selectively transmit or not transmit at least one further channel quality indicator fragment based on the determined at least one characteristic of the channel, such as a presence or absence of fading. Corresponding method and computer programs are also disclosed, as is a base station operable with a user equipment having the channel quality indicator module.

### CLAIM OF PRIORITY FROM COPENDING PROVISIONAL PATENT APPLICATION

This patent application claims priority under 35 U.S.C. §119(e) from Provisional Patent Application No. 60/850,108, filed Oct. 6, 2006, the disclosure of which is incorporated by reference herein in its entirety.

### TECHNICAL FIELD

The exemplary and non-limiting embodiments of this invention relate generally to wireless communication systems, methods, devices and computer program products and also relate to measurement reporting techniques between a user equipment and a network.

### BACKGROUND

The following abbreviations are herewith defined:
3GPP third generation partnership project
CQI channel quality indicator
DCT discrete cosign transform
LTE long term evolution
OFDM orthogonal frequency division multiplex
Node-B base station
PRB physical resource block
PS packet scheduler
SC-FDMA single carrier, frequency division multiple access
SINR signal to interference noise ratio
UE user equipment
UMTS universal mobile telecommunications system
UTRAN UMTS terrestrial radio access network

A proposed communication system known as evolved UTRAN (E-UTRAN, also referred to as UTRAN-LTE) is currently under discussion within the 3GPP. The current working assumption is that the DL access technique will be OFDM, and the UL technique will be SC-FDMA. The use of this system will provide an opportunity to do link adaptation and user multiplexing in the frequency domain. In order to accomplish this adaptation in the frequency domain, it is important that packet scheduler and link adaptation units in the Node-B have knowledge of the instantaneous channel quality. This is obtained through the signaling of CQI reports from the different UEs.

As is stated in 3GPP TR 25.814, V7.0.0 (2006-06), 3rd Generation Partnership Project; Technical Specification Group Radio Access Network; Physical layer aspects for evolved Universal Terrestrial Radio Access (UTRA) (Release 7), in Section 7.1.3.1.1.1.1, “Channel Quality Indicator”, the frequency dimension of OFDM symbols can be organized into an integer number of CQI bands across all carrier bandwidth modes, with each CQI band bandwidth corresponding to x (e.g. x=25 or 50) number of consecutive sub-carriers. The granularity of the CQI band bandwidth should be multiples of the minimum resource block bandwidth.

Channel quality indicator (CQI) feedback from the UE which indicates the downlink channel quality can be used at the Node-B at least for the following purposes:

time/frequency selective scheduling;

selection of modulation and coding scheme;

interference management; and

transmission power control for physical channels, e.g., physical/L2-control signaling channels.

It is also said that various techniques or combinations thereof can be considered for reducing CQI feedback which include (as examples) the following:

only feedback information from the top M strongest CQI bands;

differential feedback information in time or frequency;

bitmap techniques indicating which bands reflect a reported CQI value;

hierarchical tree structure based approaches; and

using a set of (orthogonal) functions to approximate frequency selective fading profile (e.g., DCT).

The inventors note that ideally the CQI reports would be available with infinite resolution and ‘zero’ delay. However, this would require the uplink signaling bandwidth to be infinite. As such, to transfer these CQI reports the measured values are quantized to an agreed upon set of levels, and transmitted with a certain finite delay.

It can be shown that a total number of 4-5 bits are needed per CQI report in order to obtain near-optimum performance of the link adaptation/packet scheduling in the frequency domain, when also considering signaling delays and measurement errors. However, as these measurement reports need be updated frequently, they would require a large amount of uplink signaling bandwidth. Further, each CQI transmission from the UE consumes some finite amount of power.

It has been proposed in 3GPP TSG RAN#43 (Seoul, Korea; Nov. 7-11, 2005; R1-051334) to use threshold-based CQI reporting associated with a bitmap indicating which resource blocks are suited for transmission. Further, consideration has been made in 3GPP TSG RAN WSG1#44 (Denver, USA; Feb. 13-17, 2006; R1-060641) of making the CQI reporting event-based such that CQI report updates are only sent whenever they have changed by some predetermined amount. Another approach proposed in 3GPP TSG RAN1#44 (Helsinki, Finland; Jan. 23-25, 2006; R1-060018) would use time staggering such that a CQI report is sent in smaller pieces (such that it will require several sub-frames to transmit the full CQI report).

None of these proposals, however, provides a truly optimum solution to the CQI signaling problem(s).

### SUMMARY OF THE EXEMPLARY EMBODIMENTS OF THIS INVENTION

The foregoing and other problems are overcome, and other benefits are realized by the use of the exemplary embodiments of this invention.

In accordance with a first aspect of the exemplary embodiments of this invention a method comprises preparing a channel quality indicator report comprised of a plurality of channel quality indicator fragments; transmitting a first channel quality indicator fragment to a wireless network, where the first channel quality indicator fragment comprises information sufficient for use by a network node; and selectively transmitting or not transmitting at least one subsequent channel quality indicator fragment based on at least one determined characteristic of the channel.

In accordance with a further aspect of the exemplary embodiments of this invention an apparatus comprises a radio frequency transceiver and a channel quality indicator module coupled to the transceiver. The channel quality indicator module is configurable to determine at least one characteristic of a channel received through the transceiver and to prepare a channel quality indicator report comprised of a plurality of channel quality indicator fragments. The channel quality indicator module is further configurable to transmit a first channel quality indicator fragment to a wireless network through the transceiver, where the first channel quality indicator fragment comprises information sufficient for use by a network node to make a resource scheduling decision, and to selectively transmit or not transmit at least one further channel quality indicator fragment based on the determined at least one characteristic of the channel.

In accordance with another aspect of the exemplary embodiments of this invention an apparatus includes a transceiver configurable to transmit to and receive from wireless communication channels, and further includes a channel quality unit configurable to determine a value representative of an overall quality of a set of channels and to transmit during a reporting interval an indication of the determined value. The channel quality unit is further configurable to selectively transmit or not transmit, based on at least one characteristic of the set of channels, during at least one subsequent reporting interval an indication of a determined overall quality of a sub-set of the set of channels.

In accordance with another aspect of the exemplary embodiments of this invention a method comprises, at a user equipment, representing values indicative of channel quality indications for a plurality of channels of a set of wireless channels using a tree structure having a plurality of nodes arranged in levels from a highest level to a lowest level, where each node corresponds to a value, where lower levels have higher numbers of nodes as compared to a number of nodes at higher levels, where nodes in higher levels of the tree structure correspond to values representative of a larger number of wireless channels in the set, and nodes in lower levels correspond to values representative of a smaller number of wireless channels in the set, and where a single node at a root of the tree structure corresponds to a value representative of overall quality for the plurality of channels of the set of wireless channels. The method further includes transmitting the value associated with the single node at the root of the tree structure to a wireless network node during a first reporting interval and selectively one of transmitting or not transmitting values associated with one or more lower level nodes of the tree structure during one or more subsequent reporting intervals. Selectively not transmitting is performed in response to a determination that additional reported values would not significantly change operation of the wireless network node in making at least one resource allocation decision that affects the user equipment.

In accordance with a still further aspect of the exemplary embodiments of this invention an apparatus includes a receiver configurable to receive during a reporting interval a first indication of a value representative of an overall quality of a set of channels and configurable to receive during at least one subsequent reporting interval at least one additional indication of at least one additional value representative of a quality of a subset of the set of channels. The apparatus also includes a scheduling module configurable, using at least the first received indication, to schedule resources associated with the channels in the set.

### BRIEF DESCRIPTION OF THE DRAWINGS

In the attached Drawing Figures:

FIG. 1 shows a simplified block diagram of various electronic devices that are suitable for use in practicing the exemplary embodiments of this invention.

FIG. 2 illustrates an exemplary set of measurement reports arranged logically into a tree structure representing potential incremental information to transmit to the Node-B.

FIG. 3 shows an example of a UE controlled self-termination CQI technique in accordance with the exemplary embodiments of this invention.

FIG. 4 is a logic flow diagram that this illustrative of the operation of a method, and a computer program product, in accordance with exemplary embodiments of this invention.

FIG. 5 is a logic flow diagram that this illustrative of the operation of a method, and a computer program product, in accordance with further exemplary embodiments of this invention.

### DETAILED DESCRIPTION

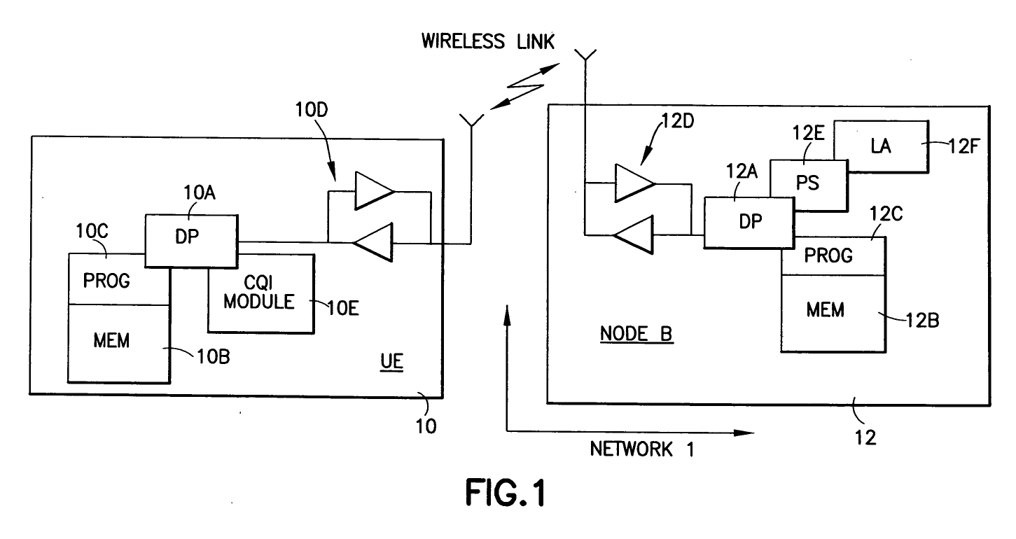

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node-B (base station) 12. The network 1 may include at least one network control element (not shown) that is coupled to the Node-B 12. The UE 10 includes a data processor (DP) 10A, a memory (MEM) 10B that stores a program (PROG) 10C, and a suitable radio frequency (RF) transceiver 10D for bidirectional wireless communications with the Node-B 12, which also includes a DP 12A, a MEM 12B that stores a PROG 12C, and a suitable RF transceiver 12D. The PROGs 10C and 12C may include program instructions that, when executed by the associated DP, enable the electronic device to operate in accordance with the exemplary embodiments of this invention, as will be discussed below in greater detail.

Related more specifically to the exemplary embodiments of this invention, the UE 10 is shown to include a CQI unit or module 10E that is assumed to be responsible for generating and transmitting CQI reports in accordance with the exemplary embodiments of this invention, and the Node-B 12 is assumed to include a packet scheduler (PS) 12E and link adaptation (LA) 12F units or modules that respond to the CQI reports sent by the UE 10. The modules 10E, 12E and 12F may be embodied in software, firmware and/or hardware, as is appropriate. In general, the exemplary embodiments of this invention may be implemented at least in part by computer software executable by the DP 10A of the UE 10 and by the DP 12A of the Node-B 12, or by hardware, or by a combination of software and hardware.

The various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B and 12B may be of any type suitable to the local technical environment and may be implemented using any suitable data storage technology, such as semiconductor-based memory devices, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

One suitable and non-limiting technique for the UE 10 to make CQI measurements in preparation for preparing the CQI measurement reports, in accordance with the exemplary embodiments of this invention, is specified in 3GPP TS 25.214, V6.7.1 (2005-12), 3rd Generation Partnership Project; Technical Specification Group Radio Access Network; Physical layer procedures (FDD) (Release 6)). For example, reference may be made to Section 6A.2 “Channel quality indicator (CQI) definition”.

In copending U.S. patent application Ser. No. 11/724,860, filed Mar. 16, 2007, entitled: “Apparatus, Methods and Computer Program Products Providing Signaling of Time Staggered Measurement Reports and Scheduling in Response Thereto”, by Frank Frederiksen and Troels Kolding (incorporated by reference herein) there is described the use of tree-based signaling and time-staggering of the CQI reports to beneficially reduce the CQI signaling bandwidth by a gradual and tree-based transmission of the full CQI report. One non-limiting advantage obtained by the use of this technique is that even the first partial report can be used by the Node-B 12 for scheduling and adaptation, with minimal delay, while more accurate scheduling can be achieved as more fragments of the CQI report are received.

The exemplary embodiments of the present invention utilize these properties to further provide options for reducing UE 10 power consumption. Note, however, that the exemplary embodiments of this invention are not constrained for use with just the procedures disclosed in copending U.S. patent application Ser. No. 11/724,860, and may be employed to advantage with any CQI scheme wherein fragments of the CQI report are transmitted over time (e.g., staggered) such that the system can collect the complete CQI report, and where any fragment can be used for initial scheduling (although the scheduling and adaptation accuracy will generally increase as more CQI fragments are received at the scheduling node, such as the PS 12E).

The exemplary embodiments of this invention provide an installed framework, rule, and algorithm between the Node-B 12 and the UE 10 such that the UE 10 may self-terminate its CQI transmission when it is determined that a further transmission will not significantly improve the CQI accuracy. The use of the exemplary embodiments of this invention conserves UE 10 transmission power and bandwidth, while simultaneously providing near-100% network/link performance of the downlink.

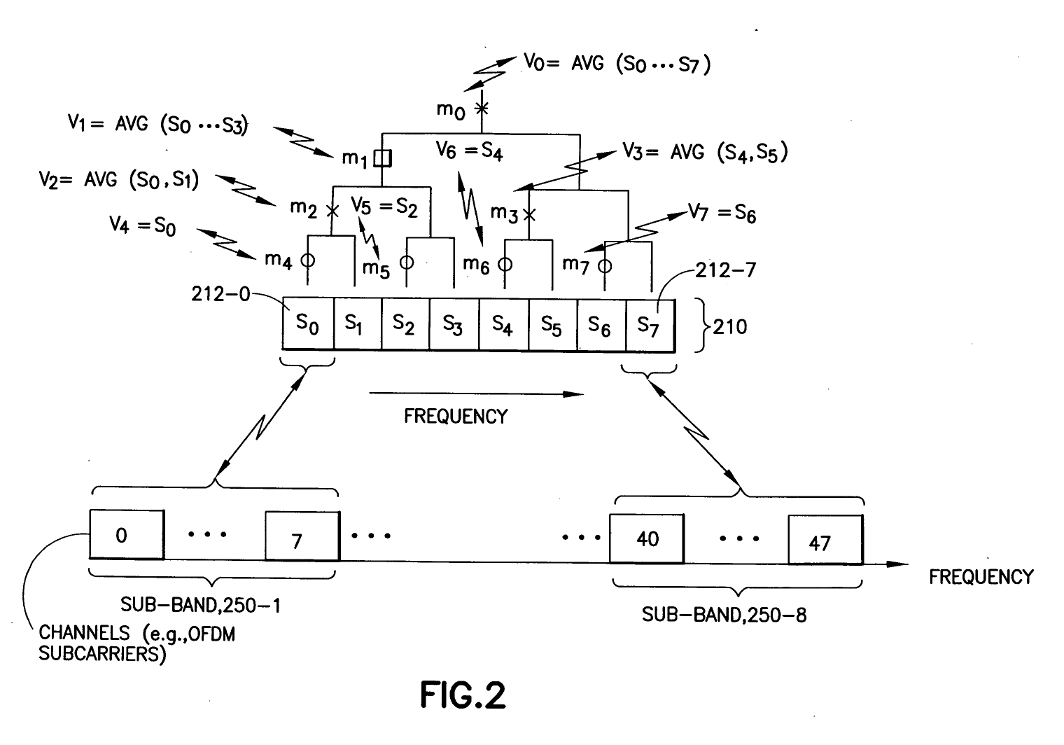

To illustrate an exemplary embodiment of the CQI reporting approach disclosed in copending U.S. Provisional Patent Application No. 60/783,215, reference is made to FIG. 2 where a complete CQI report 210 is divided into, as a non-limiting example, eight sub-reports 210-0 through 210-7, respectively, each sub-report including a corresponding value from the values s₀-s₇. Each sub-report 210 may, for example, represent a group of subcarriers, a so-called resource block, in the frequency domain. This is true, in an exemplary embodiment, because the only reference symbols that exist are for determining the channel quality on part of the sub-carriers within a resource block. A specific, but non-limiting example is shown in FIG. 2, where 48 OFDM subcarriers 0-47, are shown. The sub-report 210-0 corresponds to a value, s₀, for the subcarriers zero through seven, while the sub-report 210-7 corresponds to a value, s₇, for the subcarriers 40-47. The technique may be expanded to cover any number of sub-reports per CQI report. The sub-report 212 conveys desired information and may represent, as non-limiting examples, the SINR or supported data rate for each sub-band 250-1 through 250-8 in the frequency domain. It is noted that a channel for a single user is defined by a combination of resources, such as a set of physical resource blocks, channel coding, and modulation.

However, in order to optimize the total transmission, the sub-reports 212 are not sent directly. Instead, the CQI module 12E represents the complete CQI report 210 as converted into eight CQI messages (denoted m₀-m₇ in FIG. 2), which may be transmitted in an exemplary embodiment in sequence from m₀ to m₇. Again, the number of reports is chosen for the specific example considered here. The technique may be generalized to other cases as well. In the abovementioned case, it requires eight transmissions before the complete CQI report 210 is received at the Node-B 12. The messages are communicated in a time-staggered manner because, for example, message m₀ is communicated in a first sub-frame, while after some delay (e.g., of the remainder of the frame time), a message m₁ is communicated in a second sub-frame. It is noted that message m₀ is received in a reception interval of the first sub-frame and message m₁ is received in a reception interval of the second sub-frame. It is further noted that CQI information is typically assigned certain time periods for transmission/reception, generally called CQI reporting intervals. Thus, the first and second sub-frames represent CQI reporting intervals in this example.

The message tree notation and hierarchical structure shown in FIG. 2 denotes over which sub-bands 250 each of the eight messages is created/measured. The first message sent by the UE 10 (m₀ represented by the asterisk) is in the top of the tree (which may be designated as the root node or the trunk and is at the highest level) and is thus created by creating a value v₀ that averages all the sₓ values from s₀ to s₇. The next message is m₁ and is represented by the first branch (and node) in the tree. As m₁ is located one level lower than m₀, the m₁ message is obtained by determining a value v₁ by averaging the sₓ values s₀ to s₃. Significantly, by having knowledge of the values (v₀ and v₁) in m₁ and m₀, the Node-B 12 can automatically determine the average CQI value of s₄ to s₇ without explicit signaling (discussed below is the case where a CQI message m₀ . . . m₇ is not received correctly). The procedure continues in the same manner to send m₂, then to send messages in progressively lower ‘levels’ of the tree shown in FIG. 2. In general, messages (and their corresponding nodes) in a particular level represent the same number of the most detailed sub-reports 212 (having values s₀ through s₇ in FIG. 2), or substantially the same number (e.g., differing by one) where the total number of the most detailed sub-reports 212 is not evenly divisible by the number of messages in a particular level. Each new message increases the granularity and accuracy of the report (i.e., converging towards the most accurate CQI estimates of the original s₀ to s₇ values).

It is noted that FIG. 2 is illustrated using an even number of sub-reports 212. The tree structure shown is easily adapted to a number of leaves that is described by 2^{N}. However, in LTE or other systems, it might not be possible to write messages as 2^{N}. Regardless, to 2^{N} property, as shown by the following non-limiting example:

1. If there are 50 reports, average over the full bandwidth;

2. When calculating the second node (i.e., the value of the message at the second level), use 25 PRBs for each node;

3. Third nodes (i.e., the values of the messages) at the third level: each parent node is divided into 12 and 13 PRBs each;

4. Fourth nodes (i.e., the values of the messages) at fourth level: each parent node is divided into all even or an even and an odd numbers of PRBs: the parent node with 12 PRBs is divided into 6+6, and the parent node with 13 PRBs is divided into 6+7 PRBs;

5. Fifth nodes (at fifth level): 3+3, 3+3, 3+3, and 3+4 PRBs; and

6. Sixth nodes (at sixth, lowest level): As it is not possible to divide the blocks of ‘3’ PRBs in a simple way, at this level of the tree structure one may consider each PRB individually. Still, it should be remembered that even in this case, one can derive the value of a PRB at this lower layer of the tree by knowing the value at the fifth node and two of the reports at the sixth level.

Note that the order in which the various messages may be transmitted need not follow the sequential numbering of messages shown in FIG. 2, though preferably all messages in one level of the tree are sent prior to sending any messages from lower levels of that same tree. For example, m₀ would be sent first, followed by m₁. Messages m₂ and m₃ are sent after m₁, in any order that might be specific to a particular implementation. Following transmittal of m₂ and m₃, messages m₄, m₅, m₆ and m₇ are sent, again in any particular order that might be advantageous for a particular implementation. The order is preferably pre-determined so that the receiver knows which sub-reports 212 are reflected in any particular received message. While FIG. 2 shows only four different levels of messages (apart from the sub-reports 212-0 through 212-7, containing values s₀ through s₇, respectively), any number of message levels may be implemented where there are more or less than the eight illustrated sub-reports 212.

Having thus discussed certain aspects of the exemplary embodiments of this invention described in copending U.S. patent application Ser. No. 11/724,860, in accordance with exemplary embodiments of this invention the UE 10 transmission overhead may be adjusted by imposing rules on what levels of the CQI reporting tree should be transmitted and estimated by the UE 10. For example, if the UE 10 should happen to experience a fully flat or substantially flat fading signal environment, so that all sₓ values are the same or about the same, then only m₀ may be selected to report to the Node-B 12.

Further in accordance with the exemplary embodiments of this invention, the UE 10 may realize that the channel conditions that it is experiencing are currently static, and that there is no need to transmit anything after m₀. Due to the properties of the tree-based signaling method, this does not pose a problem in the network 1, and the UE 10 may autonomously determine to not send the remainder of the CQI measurement report. Since the Node-B 12 already has sufficient information to perform scheduling (e.g., based at least on receiving the first measurement report m₀) it can proceed without receiving, for example, measurement reports m₂, . . . , m₇.

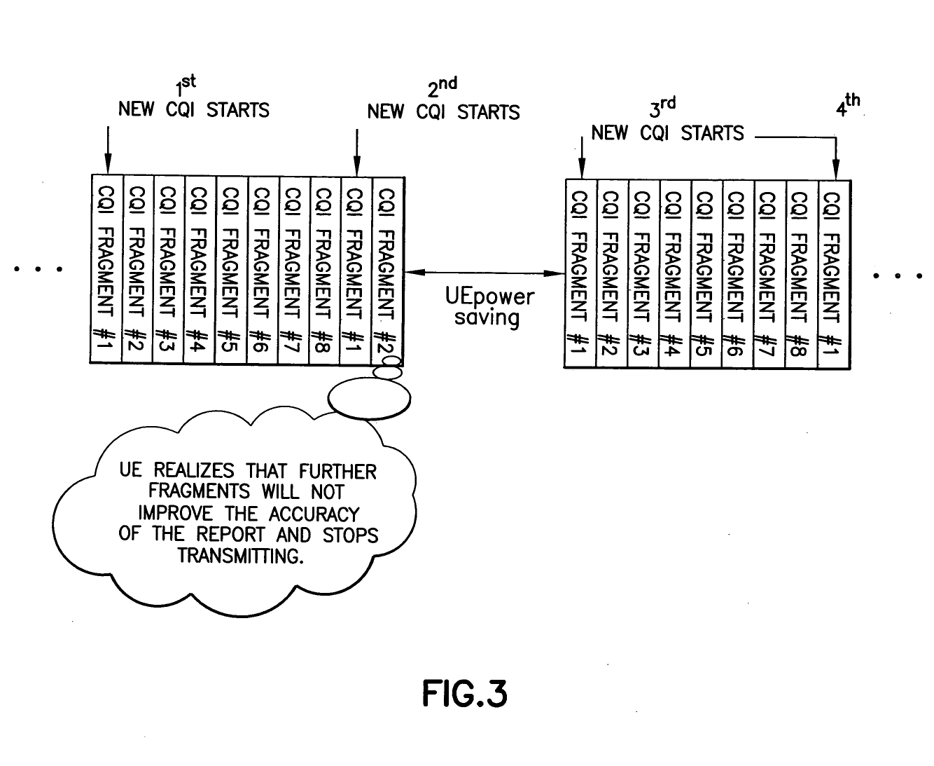

This concept is illustrated in FIG. 3, where it is assumed that the UE 10 is transmitting CQI measurement fragments according to some pre-agreed time interval. For the exemplary embodiments of this invention it should be noted that the UE 10 and the Node-B 12 both know (are synchronized) when the first CQI fragment (#1) is received. In the illustrated, non-limiting example of FIG. 3 it can be observed that there are in total eight fragments in a complete CQI report (such as, but not limited to, the eight CQI messages m₀-m₇ shown in FIG. 2). In the second CQI reporting interval, the CQI module 10E of the UE 10 determines that sending the full tree information provides no additional value compared to just sending the first two CQI fragments. This situation may occur, for example, if the channel is currently experiencing nearly flat fading conditions, and only a two-region separation is required. In this case the UE 10 terminates its CQI measurement reporting transmissions, thereby conserving both power and the wireless uplink bandwidth. In this case the Node-B 12 may simply receive noise (or some other indication of a lack of a signal) when it expects to receive the CQI measurement report(s), and can readily determine that the UE 10 has autonomously terminated the transmission of the CQI measurement report fragments.

After not transmitting CQI fragments #3-#7 (in this non-limiting example), the UE 10 transmits the next CQI fragment (#1) at the start of the next (third) CQI interval at the agreed time, and thus synchronization is re-established between the Node-B 12 and the UE 10. Note that while FIG. 3 shows the UE 10 transmitting all eight CQI measurement report fragments during the third CQI interval, in accordance with the exemplary embodiments of this invention the UE 10 may determine to transmit less than all of the full set of CQI measurement report fragments.

Note further that the un-transmitted CQI measurement report fragments need not all be adjacent. As one non-limiting example, and referring also to the measurement tree example of FIG. 2, depending on measured channel conditions the UE 10 may determine to transmit fragments corresponding to m₀, m₁ and m₃, corresponding in FIG. 3 to CQI fragments #1, #2 and #4 (as but one non-limiting example). Due to the measurement reporting synchronization between the UE 10 and the Node-B 12, the Node-B 12 will recognize from the times of reception which CQI fragments are being reported.

It should be noted that while the example of FIG. 3 shows the CQI fragments being temporally adjacent to one another, in practice some (known) period of time may be present between each the reporting of each CQI fragment.

Clearly, the use of the exemplary embodiments of this invention provides for UE 10 power conservation when the instantaneous channel conditions are such that the UE 10 determines that a full CQI report is not needed by the Node-B 12 to make a scheduling decision.

It can be noted that if for some reason the first CQI fragment is not received by the Node-B 12, then the Node-B 12 will not have knowledge of the CQI for a particular CQI interval if the UE 10 then terminates the transmission of the following CQI fragments. However, this situation may be handled by a rule (e.g., always transmit at least X CQI fragments (e.g., where X=2, or X=3)), and by maintaining control error probabilities at an appropriate level.

It may also be desirable to impose a rule to prevent the UE 10 from basing the transmit/not transmit decision solely on a UE 10 goal to minimize power consumption, without regard to network performance related to the sending CQI reports.

Based on the foregoing it should be apparent that the exemplary embodiments of this invention provide a method, apparatus and computer program product(s) to provide a UE self-termination technique for time-staggered CQI reporting methods to enable the UE 10 to make a credible assessment of when to terminate the transmission of at least part of a CQI report.

It may be further appreciated that the exemplary embodiments of this invention provide a method, apparatus and computer program product(s) to provide a UE with discontinuous transmission (DTX) procedure for reporting CQI information, where a DTX decision is made autonomously by the UE 10 based at least on channel conditions determined by the UE.

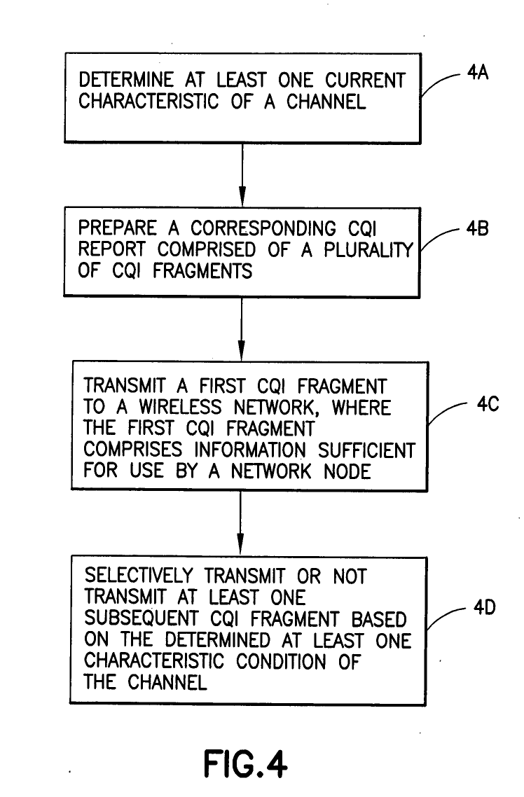

Referring to FIG. 4, in accordance with a method that is an exemplary aspect of this invention a UE determines at least one current characteristic of a channel (Block 4A); prepares a corresponding CQI report comprised of a plurality of CQI fragments (Block 4B); transmits a first CQI fragment to a wireless network, where the first CQI fragment comprises information sufficient for use by a network node (Block 4C); and selectively transmits or does not transmit at least one subsequent CQI fragment based on the determined at least one characteristic condition of the channel (Block 4D).

In the method of the preceding paragraph, where the CQI report comprises a plurality of CQI sub-reports for a CQI band bandwidth corresponding to some number of consecutive sub-carriers, and where the first CQI fragment comprises information descriptive of the plurality of the CQI sub-reports.

In the method of the preceding two paragraphs, where the determined at least one characteristic is comprised of a presence or an absence of a fading condition over at least a portion of the CQI band bandwidth.

In the method of the preceding three paragraphs, where the first CQI fragment comprises information sufficient for use by the network node in performing at least one of time/frequency selective scheduling, selection of a modulation and coding scheme, interference management and transmission power control for physical channels.

In the method of the preceding four paragraphs, where the CQI report comprised of the plurality of CQI fragments is logically organized into a hierarchical tree structure, and where the first CQI fragment is one nearest the root of the tree structure.

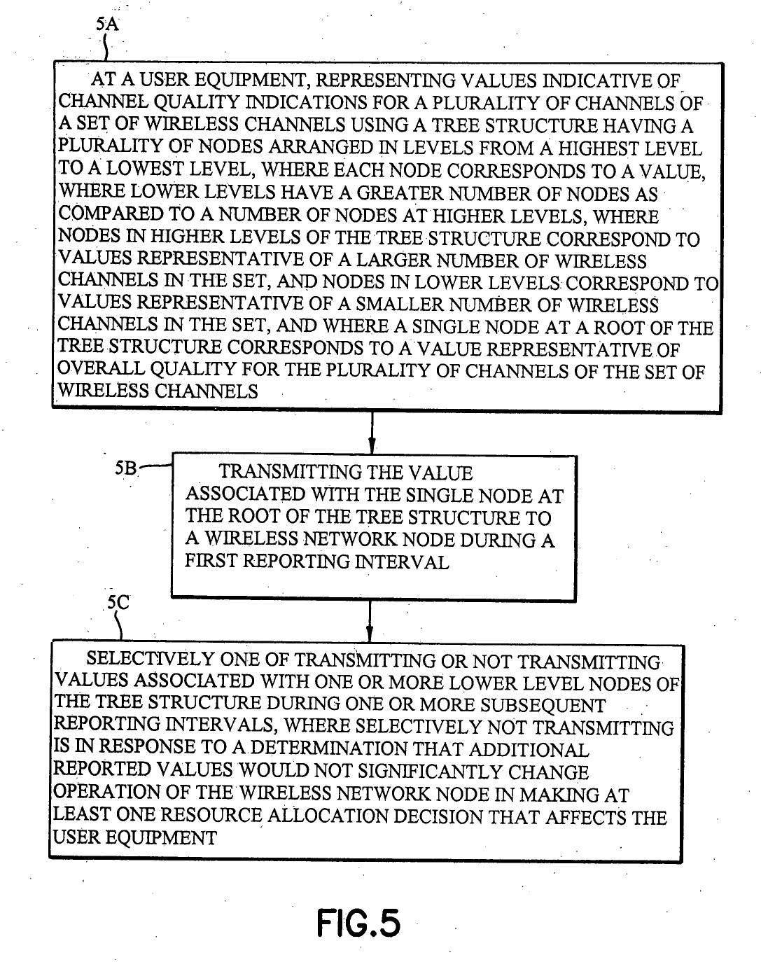

Further in accordance with the exemplary embodiments of this invention, and referring to FIG. 5, a method includes (Block 5A), at a user equipment, representing values indicative of channel quality indications for a plurality of channels of a set of wireless channels using a tree structure having a plurality of nodes arranged in levels from a highest level to a lowest level, where each node corresponds to a value, where lower levels have a greater number of nodes as compared to a number of nodes at higher levels, where nodes in higher levels of the tree structure correspond to values representative of a larger number of wireless channels in the set, and nodes in lower levels correspond to values representative of a smaller number of wireless channels in the set, and where a single node at a root of the tree structure corresponds to a value representative of overall quality for the plurality of channels of the set of wireless channels. At Block 5B the method includes transmitting the value associated with the single node at the root of the tree structure to a wireless network node during a first reporting interval, and at Block 5C the method further includes selectively one of transmitting or not transmitting values associated with one or more lower level nodes of the tree structure during one or more subsequent reporting intervals, where selectively not transmitting is in response to a determination that additional reported values would not significantly change operation of the wireless network node in making at least one resource allocation decision that affects the user equipment.

Note that the various blocks shown in FIGS. 4 and 5 may be viewed as method steps, and/or as operations that result from operation of computer program code, and/or as a plurality of coupled logic circuit elements constructed to carry out the associated function(s).

As such, in accordance with a computer program that is another exemplary aspect of this invention, execution of the computer program by a data processor of a UE results in operations that comprise: determining at least one current characteristic of a channel; preparing a corresponding CQI report comprised of a plurality of CQI fragments; transmitting a first CQI fragment to a wireless network, where the first CQI fragment comprises information sufficient for use by a network node; and selectively transmitting or not transmitting at least one subsequent CQI fragment based on the determined at least one characteristic condition of the channel.

In the computer program of the preceding paragraph, where the CQI report comprises a plurality of CQI sub-reports for a CQI band bandwidth corresponding to some number of consecutive sub-carriers, and where the first CQI fragment comprises information descriptive of the plurality of the CQI sub-reports.

In the computer program of the preceding two paragraphs, where the determined at least one characteristic is comprised of a presence or an absence of a fading condition over at least a portion of the CQI band bandwidth.

In the computer program of the preceding three paragraphs, where the first CQI fragment comprises information sufficient for use by the network node in performing at least one of time/frequency selective scheduling, selection of a modulation and coding scheme, interference management and transmission power control for physical channels.

In the computer program of the preceding four paragraphs, where the CQI report comprised of the plurality of CQI fragments is logically organized into a hierarchical tree structure, and where the first CQI fragment is one nearest the root of the tree structure.

A further exemplary aspect of this invention encompasses a device that comprises a radio frequency transceiver and a CQI module coupled to the transceiver, where the CQI module is adapted to determine at least one current characteristic of a channel as received through the transceiver and to prepare a corresponding CQI report comprised of a plurality of CQI fragments. The CQI module is further adapted to transmit a first CQI fragment to a wireless network, where the first CQI fragment comprises information sufficient for use by a network node, and to selectively transmit or not transmit at least one subsequent CQI fragment based on the determined at least one characteristic condition of the channel. At least the CQI module may be embodied in whole or in part in at least one integrated circuit package or module.

In the device of the preceding paragraph, where the CQI report comprises a plurality of CQI sub-reports for a CQI band bandwidth corresponding to some number of consecutive sub-carriers, and where the first CQI fragment comprises information descriptive of the plurality of the CQI sub-reports.

In the device of the preceding two paragraphs, where the determined at least one characteristic is comprised of a presence or an absence of a fading condition over at least a portion of the CQI band bandwidth.

In the device of the preceding three paragraphs, where the first CQI fragment comprises information sufficient for use by the network node in performing at least one of time/frequency selective scheduling, selection of a modulation and coding scheme, interference management and transmission power control for physical channels.

In the device of the preceding four paragraphs, where the CQI report comprised of the plurality of CQI fragments is logically organized into a hierarchical tree structure, and where the first CQI fragment is one nearest the root of the tree structure.

In accordance with exemplary embodiments of this invention the values may be represented using a tree structure having a plurality of levels from a highest level to a lowest level and a number of nodes at each level, where each node corresponds to a value, where lower levels have higher numbers of nodes as compared to a number of nodes at higher levels, and where a single node at the highest level corresponds to a value representative of the overall quality. In general, nodes in higher levels of the tree structure correspond to values representative of a larger number of channels in the set, and nodes in lower levels correspond to values representative of a smaller number of channels in the set. All of the nodes at any one level beneath the highest level may correspond to all of the channels in the set, and where determining at least one additional value may further comprise determining values for only a portion of the nodes at any one level beneath the highest level. It is within the scope of the exemplary embodiments to encode the values to create corresponding ones of indications of quality. The encoding may be performed using a larger number of bits to encode the value corresponding to the highest level as compared to a number of bits used to encode a single value corresponding to the lowest level.

In accordance with the exemplary embodiments of this invention when the UE 10 determines at least one additional value it may determine a plurality of additional values representative of qualities of different subsets of the set of channels, and in this case the UE 10 can selectively transmit or not transmit, in a plurality of subsequent reporting intervals, indications of the plurality of additional values.

Note that when determining a plurality of additional values the UE 10 can perform a plurality of determinations over a time interval for particular ones of the additional values, and an average of values determined in the determinations is used as an associated one of the particular additional values.

In general, different subsets of the set of channels can be selected to increase the accuracy of the qualities, relative to qualities of single ones of the channels in associated subsets, and when transmitting the UE 10 transmits less accurate values in earlier reporting intervals and more accurate values in later reporting intervals, unless the UE 10 autonomously determines to terminate transmission of the more accurate values, as discussed above.

It should thus be apparent that a method in accordance with e exemplary embodiments of this invention encompasses a user equipment that represents values indicative of channel quality indications for a plurality of channels of a set of wireless channels using a tree structure having a plurality of nodes arranged in levels from a highest level to a lowest level, where each node corresponds to a value, where lower levels have higher numbers of nodes as compared to a number of nodes at higher levels, where nodes in higher levels of the tree structure correspond to values representative of a larger number of wireless channels in the set of wireless channels and nodes in lower levels correspond to values representative of a smaller number of wireless channels in the set, and where a single node at a root of the tree structure corresponds to a value representative of overall quality for the plurality of channels of the set of wireless channels. The method further entails transmitting the value associated with the single node at the root of the tree structure to a wireless network node during a first reporting interval and selectively one of transmitting or not transmitting values associated with one or more lower level nodes of the tree structure during one or more subsequent reporting intervals. The step of selectively not transmitting is in response to a determination that additional reported values would not significantly change operation of the wireless network node in making at least one resource allocation decision that affects the user equipment. The at least one resource allocation decision may include at least one of time/frequency selective scheduling, selection of a modulation and coding scheme, interference management and power control.

Further still, it should be appreciated that the exemplary embodiments of this invention pertain to an apparatus and a to method to operate the apparatus to receive, during a reporting interval a first indication of a value representative of an overall quality of a set of channels, to receive during at least one subsequent reporting interval at least one additional indication of at least one additional value representative of a quality of a subset of the set of channels, and to schedule, using at least the first received indication, resources associated with the channels in the set.

The various exemplary embodiments described above may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
preparing a channel quality indicator report comprised of a plurality of channel quality indicator fragments;
transmitting a first channel quality indicator fragment to a wireless network, where the first channel quality indicator fragment comprises information sufficient for use by a network node; and
selectively transmitting or not transmitting at least one subsequent channel quality indicator fragment based on at least one determined characteristic of the channel.

2. The method of claim 1, where the channel quality indicator report comprises a plurality of channel quality indicator sub-reports for a channel quality indicator band bandwidth corresponding to a plurality of consecutive sub-carriers, and where the first channel quality indicator fragment comprises information descriptive of the plurality of the channel quality indicator sub-reports.

3. The method of claim 1, where the at least one determined characteristic is comprised of a presence or an absence of a fading condition over at least a portion of a channel quality indicator band bandwidth.

4. The method of claim 1, where the first fragment comprises information sufficient for use by the network node in performing at least one of time/frequency selective scheduling, selection of a modulation and coding scheme, interference management and transmission power control for physical channels.

5. The method of claim 1, where the channel quality indicator report comprised of the plurality of channel quality indicator fragments is logically organized into a hierarchical tree structure, and where the first fragment is one nearest the root of the tree structure.

6. The method of claim 1, where the channel quality indicator report comprises a plurality of channel quality indicator sub-reports for a channel quality indicator band bandwidth corresponding to a plurality of consecutive sub-carriers, and where the first channel quality indicator fragment comprises an average value of all of the plurality of channel quality indicator sub-reports.

7. The method of claim 1, where performance of the method is a result of execution of computer program instructions stored in a memory medium that comprises part of a user equipment.

8. An apparatus, comprising:
a radio frequency transceiver; and
a channel quality indicator module coupled to the transceiver, where the channel quality indicator module is configurable to determine at least one characteristic of a channel received through the transceiver and to prepare a channel quality indicator report comprised of a plurality of channel quality indicator fragments, said channel quality indicator module further configurable to transmit a first channel quality indicator fragment to a wireless network through said transceiver, where the first channel quality indicator fragment comprises information sufficient for use by a network node to make a resource scheduling decision, and to selectively transmit or not transmit at least one further channel quality indicator fragment based on the determined at least one characteristic of the channel.

9. The apparatus of claim 8, where at least said channel quality indicator module is embodied in whole or in part in at least one integrated circuit package or module.

10. The apparatus of claim 8, where the channel quality indicator report comprises a plurality of channel quality indicator sub-reports for a channel quality indicator band bandwidth corresponding to a plurality of sub-carriers, and where the first channel quality indicator fragment comprises information descriptive of the plurality of the channel quality indicator sub-reports.

11. The apparatus of claim 8, where the determined at least one characteristic is comprised of a presence or an absence of a fading condition over at least a portion of a channel quality indicator band bandwidth.

12. The apparatus of claim 8, where the first fragment comprises information sufficient for use by the network node in performing at least one of time/frequency selective scheduling, selection of a modulation and coding scheme, interference management and transmission power control for physical channels.

13. The apparatus of claim 8, where the channel quality indicator report comprised of the plurality of channel quality indicator fragments is logically organized into a hierarchical tree structure, and where the first fragment is one nearest the root of the tree structure.

14. The apparatus of claim 8, where the channel quality indicator report comprises a plurality of channel quality indicator sub-reports for a channel quality indicator band bandwidth corresponding to some number of consecutive sub-carriers, and where the first channel quality indicator fragment comprises an average value of all of the plurality of channel quality indicator sub-reports.

15. An apparatus, comprising:
a transceiver configurable to transmit to and receive from wireless communication channels; and
a channel quality unit configurable to determine a value representative of an overall quality of a set of channels and to transmit during a reporting interval an indication of the determined value, said channel quality unit further configurable to selectively transmit or not transmit, based on at least one characteristic of the set of channels, during at least one subsequent reporting interval an indication of a determined overall quality of a sub-set of the set of channels.

16. The apparatus of claim 15, where the value representative of the overall quality of the set of channels is sufficient for use by a network node to perform at least one of time/frequency selective scheduling, selection of a modulation and coding scheme, interference management and power control.

17. The apparatus of claim 15, where the at least one characteristic is comprised of a presence or an absence of fading across at least a portion of the set of channels.

18. The apparatus of claim 15, where the indication of the overall quality comprises an indication of an average value of a plurality of channel quality reports for individual ones of a plurality of adjacent frequency sub-bands.

19. A method, comprising:
at a user equipment, representing values indicative of channel quality indications for a plurality of channels of a set of wireless channels using a tree structure having a plurality of nodes arranged in levels from a highest level to a lowest level, where each node corresponds to a value, where lower levels have a greater number of nodes as compared to a number of nodes at higher levels, where nodes in higher levels of the tree structure correspond to values representative of a larger number of wireless channels in the set, and nodes in lower levels correspond to values representative of a smaller number of wireless channels in the set, and where a single node at a root of the tree structure corresponds to a value representative of overall quality for the plurality of channels of the set of wireless channels;
transmitting the value associated with the single node at the root of the tree structure to a wireless network node during a first reporting interval; and
selectively one of transmitting or not transmitting values associated with one or more lower level nodes of the tree structure during one or more subsequent reporting intervals, where selectively not transmitting is in response to a determination that additional reported values would not significantly change operation of the wireless network node in making at least one resource allocation decision that affects the user equipment.

20. The method of claim 19, where the at least one resource allocation decision comprises at least one of time/frequency selective scheduling, selection of a modulation and coding scheme, interference management and power control.

21. An apparatus, comprising:
a receiver configurable to receive during a reporting interval a first indication of a value representative of an overall quality of a set of channels and configurable to receive during at least one subsequent reporting interval at least one additional indication of at least one additional value representative of a quality of a subset of the set of channels; and
a scheduling module configurable, using at least the first received indication, to schedule resources associated with the channels in the set.

22. The apparatus of claim 21, where at least the scheduling module is implemented at least in part as an integrated circuit.

23. The apparatus of claim 21, where the scheduling module comprises a packet scheduling module and a link adaptation module.

24. The apparatus of claim 21, where:
wherein additional indications of different subsets of the set of channels, when received, increase accuracy of determination of quality of the channels in associated subsets, where reception of the plurality of additional values occurs so that less accurate values are received in earlier reporting intervals and more accurate values are received in later reporting intervals.

25. The apparatus of claim 21, where scheduling resources comprises at least one of time/frequency selective scheduling, selection of a modulation and coding scheme, interference management and power control.
